(19) United States
(12) Patent Application Publication
(10) Pub. No.: US 2005/0121833 A1
(43) Pub. Date: Jun. 9, 2005

(54) Processing method for ceramic

(76) Inventors: Jenn-Shing Wang, Tainan (TW); Wen-Hao Lin, Kaohsiung (TW); Chih-Cheng Chen, Fengshan City (TW)

Correspondence Address: Far East College, P.O. Box No. 6-57, Junghe, Taipei, 235, TW

(21) Appl. No.: 10/729,926

(22) Filed: Dec. 9, 2003

(51) Int. Cl. C04B 33/32

(52) U.S. Cl. 264/432; 264/654; 264/656

(57) ABSTRACT

A processing method for ceramic, having processing steps consisting of: (a) Manufacture pellets; (b) Cover the pellets with microwave dielectric; (c) Place the pellets into a microwave environment; (d) Microwave degreasing; (e) Complete degreasing. Procedural steps of the present invention primarily consist of placing the ceramic pellets in a container filled with microwave dielectric powder, placing the container within the microwave environment, and then regulating microwave power and time period for degreasing, whereupon the microwave dielectric powder surrounding and covering the pellets subsequently absorbs the microwaves and thereby facilitates indirect degreasing of the pellets.

### BACKGROUND OF THE INVENTION

(a) Field of the Invention

The present invention relates to a processing method for ceramic, whereby a manufacturing process can expedite technological processes, economizes on cost of equipment and energy resources, and quickly achieves drying and removing of adhesives, extenders or lubricants. The present invention is extremely suited to the manufacturing process of ceramic material.

(b) Description of the Prior Art

In general, ceramic material has distinctive characteristics of being brittle, and having low resilience and extensibility. The ceramic material also lacks conductivity, and can therefore be used as an excellent insulator of electricity and heat. Because the ceramic material possesses very high bonding stability, and thus has an extremely high melting point, as well as being able to maintain good chemical stability in an adverse corrosive environment. Having foresaid properties, the ceramic material has become an essential material component in engineering projects, and is employed in such areas as bricks and tiles in construction work, electronic ceramics utilized by electronic industries, high temperature engine parts, and so on, all of which are excellent examples of areas where the ceramic material is being put to use.

The ceramic material possesses high ignition point, add to this phase decomposition when subject to high temperature makes manufacturing methods of ceramic products entirely different to those employed for plastic or metal. Majority of ceramics melt at a temperature above 1500° C., and is thus almost impossible to employ melt-casting methods to mold the ceramic material. Thus the manufacturing methods employed to produce most traditional and fine ceramic products is a so-called sintering method, whereby powder or pulverized material is first molded, and subsequently heated to a sufficiently high temperature, thereby enabling the powder within the material to bond and hold together as an integral whole.

In order to facilitate easy molding of the ceramic powder into pellets, when mulling the ceramic powder, a mold assisting agent is usually added such as an adhesive, a bulking agent, a surface active agent or a lubricant to the ceramic powder, and thereafter molded into pellets. Prior to the pellets being subjected to high temperature sintering, the pellets undergo a degreasing treatment with an objective of eliminating relevant macromolecules utilized in the molding process, macromolecules eliminated include the adhesive, the bulking agent, the surface active agent or the lubricant.

The present invention does not review or assess problems involved in molding methods of the pellets, sintering, the ceramic material or composition of additives; but is particularly directed towards general problems of the degreasing treatment during a manufacturing process, and proposes an alternative method to resolving such.

In general, current prevalent degreasing treatments include a solvent degreasing treatment and a thermal degreasing treatment.

Wherein the solvent degreasing treatment involves immersing the pellets into a solvent, therewith extracting the adhesive, the bulking agent, the surface-active agent or the lubricant from the pellets. However, the solvent degreasing method causes recycling problems pertinent to environmental protection, and increases handling costs.

Whereas the thermal degreasing treatment involves placing the pellets into a heating furnace, whereby high temperature facilitates decomposition, evaporation and melting of the adhesive, the bulking agent, the surface-active agent, the lubricant or the macromolecules, and thereby achieves objective of eliminating binders. However, the heating furnace needs preheating in order to reach a required thermal degreasing temperature adequate to proceed with degreasing. This preheating time and energy requisite, with additional expended energy necessary to maintain temperature during the degreasing process over an extended period results in considerable pecuniary waste, which is an efficiency problem absolute taboo in an effective manufacturing process.

Today is an age where great importance is attached to environmental protection, particularly usage and recycling of energy resources. However, chemical solvents employed in the solvent degreasing treatment are not environmentally friendly, and frequency of usage of such chemical solvents is restrictive. The heating furnace employed in the thermal degreasing treatment is extremely energy wasteful, wherefore, there is a necessity and a demand for exploitation of the manufacturing process that can rapidly degrease, reduce wastage of energy resources, and is environmental protective.

Patent communiqué or related data regarding aforementioned problems have been published worldwide, for instance: Manufacturing Process for Complex Shaped Chromium Carbide/Aluminum Oxide Ceramic Components using Injection Molding (Republic of China patent No. 333482). According to disclosures made in aforementioned patent, many defects can be discerned that derive from procedural steps involved in the degreasing treatment. For example:

(1) Raising and lowering of temperature of the heating furnace is troublesome and wasteful of time. If time required to raise the temperature of the heating furnace from room temperature to a temperature necessary for degreasing, in addition to time required to lower temperature of the heating furnace after degreasing is completed could be shortened, then manufacturing costs can be reduced, in addition to enhancing efficiency of the manufacturing process.

(2) Incapable of completely concentrating energy in the pellets. When heating the conventional heating furnace, over 50% of the energy is absorbed through body of the heating furnace and dissipated to atmosphere. In practice, the energy required to degrease the pellets does not exceed 30%. Wasting such a large amount of energy in order to achieve an objective of degreasing is not in keeping with economic effectiveness.

(3) The heating furnace occupies space, and is not provided with maneuverability. The body of the heating furnace is bulky, and heavy. Great inconvenience results if the heating furnace needs to be moved.

(4) Cost of the heating furnace facility is high. An increased onus is put on expenditure and maintenance costs, if pollution results from decomposition of binder compounds, then problems will easily arise from the heating furnace and fireproof materials.

(5) Time limited efficacy in usage of chemical solvent is restrictive. If the chemical solvent is used for degreasing, after usage of the chemical solvent for a period of time or increasing quantity of pellets, then effectiveness of chemical extractability will certainly decrease. After-treatment of the chemical solvents that have lost efficacy is also a difficult environmental protection problem.

In addition, Republic of China patent No. 167524 proposed a method for thermal treatment of unstable ceramic by means of microwave heating, having a primary objective to apply a microwave technique in a sintering process of the ceramic material. Patent No. 167524 discloses that an appropriate amount of powder bed forms a microwave receptor, whereby the powder bed must be provided with properties of heating, protective, deoxidizing, and thermal conductive according to requirements. The properties are configured with regard to requirements of the “sintering” process of the ceramic material. However, patent No. 167524 does not confer on the “degreasing” manufacturing process of the ceramic pellets prior to the sintering process. Wherefore, patent No. 167524 fails to provide any solution to the aforementioned manufacturing problems encountered during the degreasing treatment (the solvent degreasing treatment, the thermal degreasing treatment, and so on).

### SUMMARY OF THE INVENTION

Primary steps of the present invention consist of:
(a) Manufacture pellets: After mulling ceramic powder material with an adhesive, a bulking agent or a lubricant, manufacture the pellets through molding methods such as injection or scraping;
(b) Cover the pellets with microwave dielectric: Bury the pellets in the microwave dielectric;
(c) Place into a microwave environment: Place the aforementioned pellets covered with the microwave dielectric into the microwave environment capable of generating microwaves;
(d) Microwave degreasing: Regulate microwave power and time period in the microwave environment, whereby the microwave dielectric powder absorbs the microwaves and thereby allows degreasing of the pellets embedded within the microwave dielectric powder.
(e) Complete degreasing: Acquire degreased pellets.

A primary objective of the present invention is to provide a processing method for ceramic that expedites the manufacturing process, economizes on cost, and quickly achieves drying and removing of adhesives, extenders or lubricants. The present invention is extremely suited to post thermal treatment degreasing procedures of molded pellets after mulling of high melting point ceramic powder material along with the adhesive, the extender or the lubricant, and provides a manufacturing process that can avoid having to confront problems associated with energy wastage from raising and lowering of temperature of a heating furnace and problems of bulky equipment. Procedural steps of the present invention primarily consist of placing pellets in a container filled with microwave dielectric powder, ensuring the pellets are uniformly embedded in the microwave dielectric powder, and then placing the container within a microwave field and regulating microwave power to an appropriate amount, whereupon the microwave dielectric powder surrounding and covering the pellets subsequently absorbs the microwaves and thereby facilitates indirect degreasing of the pellets.

Another objective of the present invention is to provide and perfect a technique for the processing method for ceramic that economizes on time required to raise and lower the temperature, thereby enhancing efficiency of the manufacturing process.

Yet another objective of the present invention is to provide and perfect a technique for the processing method for ceramic that utilizes a re-usable microwave dielectric, thereby preventing environment pollution.

And yet another objective of the present invention is to provide and perfect a technique for the processing method for ceramic whereby energy is concentrated, thereby achieving objective of economizing on usage of energy resources.

Still yet another objective of the present invention is to provide and perfect a technique for the processing method for ceramic where equipment is of low cost, is light and portable, thereby reducing burden of cost expenditure and is convenient for personnel to move.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow chart of a processing method for ceramic according to the present invention.

FIG. 2 shows a schematic view of an embodiment according to the present invention.

FIG. 3 shows a schematic view depicting a sintering process of an embodiment according to the present invention.

FIG. 4 shows a shows a graph plotting sintering time against temperature comparing sintering according to the present invention with that of conventional sintering means.

FIG. 5 shows a table comparing compression resistance between a finished product after sintering of ceramic material produced according to the present invention with that of a finished ceramic product produced by conventional sintering means.

### DETAILED DESCRIPTION OF THE PREFERRED EMBODIMENTS

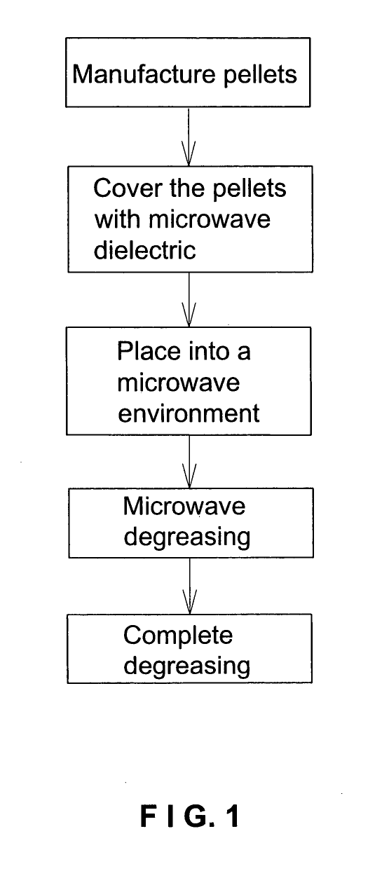

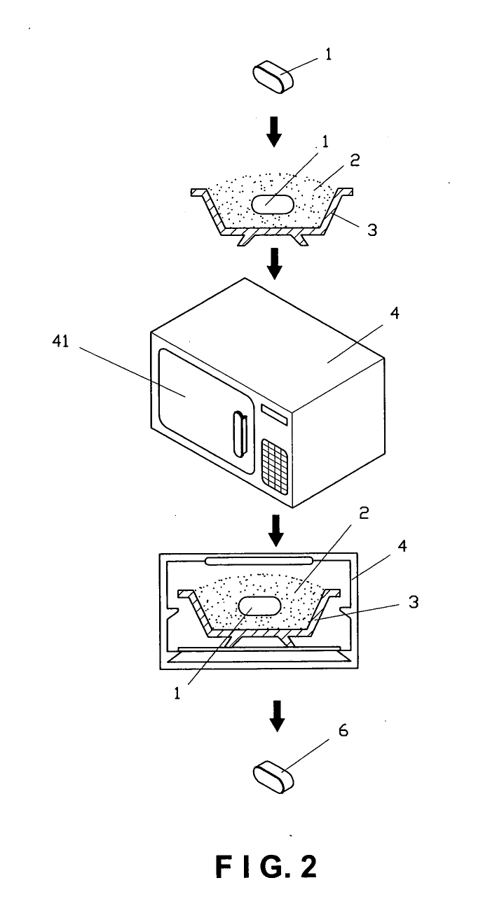

Referring to FIGS. 1 and 2, which show primary steps of a processing method for ceramic according to the present invention consisting of:
(a) Manufacture pellets: After mulling ceramic powder material with an adhesive, a bulking agent or a lubricant, manufacture the pellets through molding methods such as injection or scraping;
(b) Cover the pellets with microwave dielectric: Bury the pellets (1) in the microwave dielectric (2) (the pellets and the microwave dielectric can be placed together in a container (3);
(c) Place into a microwave environment: Place the aforementioned pellets (1) covered with the microwave dielectric (2) into the microwave environment (4) capable of generating microwaves (for instance a microwave oven);
(d) Microwave degreasing: Regulate microwave power and time period in the microwave environment (4), whereby the microwave dielectric (2) powder absorbs the microwaves and thereby allows degreasing of the pellets (1) embedded within the microwave dielectric (2) powder;
(e) Complete degreasing: Acquire degreased pellets (6) (or degreased half finished product).

During process of degreasing, because the pellets themselves manufactured from ceramic powder material cannot absorb microwaves, therefore the present invention uniformly embeds the pellets (1) in the microwave dielectric (2) powder, and the pellets (1) undergo degreasing through the surrounding microwave dielectric (2) powder absorbing the microwaves.

During aforementioned degreasing process, an operator can directly observe result of degreasing through a transparent window (41) configured in the microwave environment (4) (for instance, a microwave oven window).

The aforementioned microwave dielectric (2) powder can be compounds composed from carbides, nitrides, titanates, oxides, sulfides or other chemical compounds. Wherein the carbides can be silicon carbide (SiC), titanium carbide (TiC) or tungsten carbide (WC). The nitrides can be titanium nitride (TiN), aluminum nitride (AlN) or silicon nitride (Si₃N₄). The titanates can be molybdenum titanate, calcium titanate, strontium titanate or lead titanate. The oxides can be nickel oxide (NiO), cobalt oxide (CoO), calcium manganate (CaMnO₃), lanthanum manganate (LaMnO₃), tin dioxide (SnO₂), titanium dioxide (TiO₂), magnesium tungstate (MgWO₄), magnesium oxide (MgO), nickel oxide (NiO), strontium titanate (SrTiO₃) or strontium zirconate (SrZrO₃). The sulphides can be iron sulphide (FeS) or manganese sulphide (MnS). The chemical compounds can be ferric oxide alone or compounded with other metal oxide compounds (Fe₂O₃-MeO) including nickel oxide (NiO), cobalt oxide (CoO), molybdenum oxide (MoO), magnesium oxide (MgO), zinc oxide (ZnO), cupric oxide (CuO), lithium oxide (Li₂O), calcium oxide (CaO), iron oxide (FeO), beryllium oxide (BeO), lead oxide (PbO), strontium oxide (SrO), lanthanum oxide (La₂O₃), chromium oxide (Cr₂O₃), tin oxide (SnO₂) or tungsten oxide (WO₃). In addition, nickel oxide (NiO), cobalt oxide (CoO), molybdenum oxide (MoO), magnesium oxide (MgO), zinc oxide (ZnO), cupric oxide (CuO), lithium oxide (Li₂O), calcium oxide (CaO), iron oxide (FeO), beryllium oxide (BeO), lead oxide (PbO), strontium oxide (SrO), lanthanum oxide (La₂O₃), chromium oxide (Cr₂O₃), tin oxide (SnO₂), tungsten oxide (WO₃) can be used alone or compounded. Furthermore, the compounds such as lithium oxide (Li₂O), lanthanum oxide (La₂O₃), calcium oxide (CaO), strontium oxide (SrO), titanium dioxide (TiO₂), arsenic oxide (Sb₂O₅), tantalum oxide (Ta₂O₅), chromium oxide (Cr₂O₃) or zinc oxide (ZnO) can be added to the aforementioned oxide compounds.

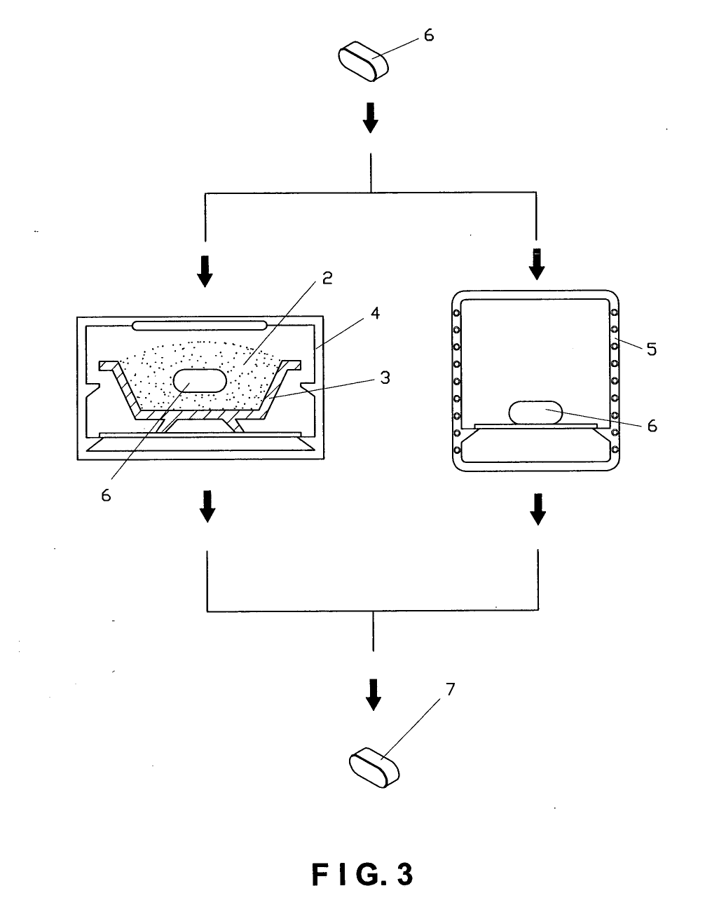

Referring to FIG. 3, which shows the degreased pellets (6) (or degreased half finished product) after the microwave degreasing, which can then undergo further direct heating to a sintering temperature. The degreased pellets (6) are put into a sintering furnace (5) already raised to a sintering temperature to undergo sintering (or make use of the microwaves in the microwave environment (4) to undergo direct sintering thereof). After a sintering process is completed, a finished product (7) is removed. Employing such follow-up sintering process, can thereby economize on time and energy sources required to gradually increase temperature.

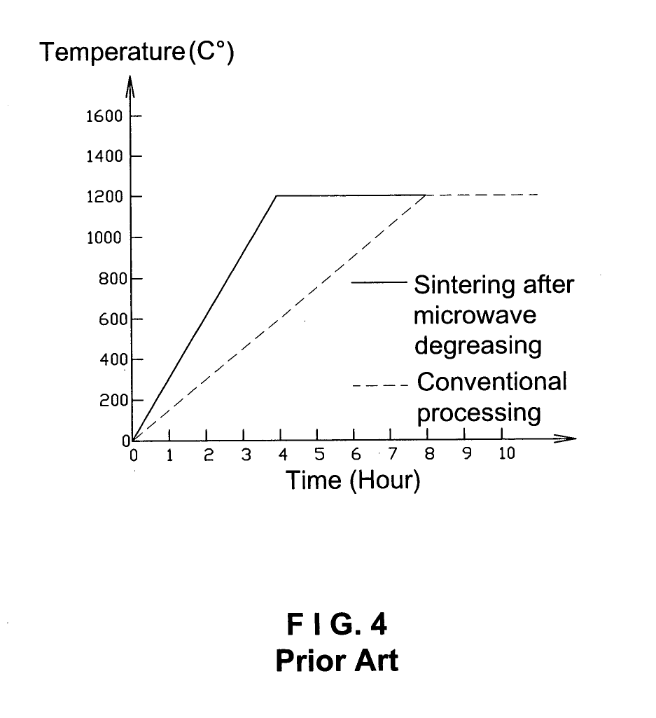

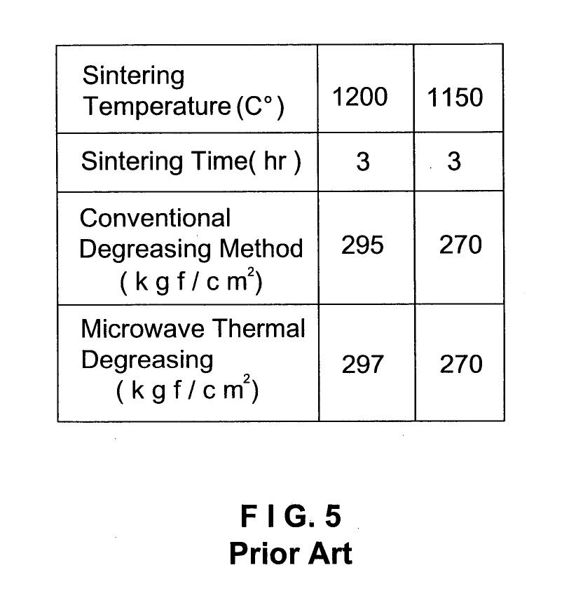

Referring to FIG. 4, which shows a graph plotting sintering time against temperature, and compares sintering of the ceramic material produced after degreasing treatment according to the present invention as depicted in FIG. 3 and described above with that of the ceramic material produced by conventional sintering means. FIG. 5 shows a table of experimental results obtained when comparing compression resistance at temperatures of 1200° C. and 1150° C. between the finished product (7) after sintering of the ceramic material produced from the degreasing treatment according to the present invention as depicted in FIG. 3 and described above with that of a finished ceramic product produced by conventional sintering means. The sintering period was 3 hours in each case, and FIG. 5 shows on comparison that the finished product acquired after sintering of the ceramic material produced from the degreasing treatment according to the present invention as depicted in FIG. 3 and described above possesses a superior sintering density.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A processing method for ceramic, having primary steps comprising:
(a) manufacture pellets: after mulling ceramic powder material with an adhesive, a bulking agent or a lubricant, manufacture the pellets;
(b) cover the pellets with microwave dielectric: bury the pellets in the microwave dielectric;
(c) place into a microwave environment: place the aforementioned pellets covered with the microwave dielectric into the microwave environment capable of generating microwaves;
(d) microwave degreasing: regulate microwave power and time period in the microwave environment, whereby the microwave dielectric powder absorbs the microwaves and thereby allows degreasing of the pellets embedded within the microwave dielectric powder;
(e) complete degreasing: acquire degreased pellets.

2. The processing method for ceramic as claimed in claim 1, wherein the degreased pellets after undergoing microwave degreasing can be directly heated to a sintering temperature, and then put into a sintering furnace already raised to a sintering temperature.

3. The processing method for ceramic as claimed in claim 1, wherein the degreased pellets after undergoing microwave degreasing can be directly heated to a sintering temperature, and then directly utilize microwaves for sintering.

4. The processing method for ceramic as claimed in claim 1, wherein the microwave dielectric powder can be compounds composed from carbides, nitrides, titanates, oxides, sulfides or other chemical compounds.

5. The processing method for ceramic as claimed in claim 4, wherein the carbides can be silicon carbide (SiC), titanium carbide (TiC) or tungsten carbide (WC).

6. The processing method for ceramic as claimed in claim 4, wherein the nitrides can be titanium nitride (TiN), aluminum nitride (AlN) or silicon nitride (Si₃N₄).

7. The processing method for ceramic as claimed in claim 4, wherein the titanates can be molybdenum titanate, calcium titanate, strontium titanate or lead titanate.

8. The processing method for ceramic as claimed in claim 4, wherein the oxides can be nickel oxide (NiO), cobalt oxide (CoO), calcium manganate (CaMnO₃), lanthanum manganate (LaMnO₃), tin dioxide (SnO₂), titanium dioxide (TiO₂), magnesium tungstate (MgWO₄), magnesium oxide (MgO), nickel oxide (NiO), strontium titanate (SrTiO₃) or strontium zirconate (SrZrO₃).

9. The processing method for ceramic as claimed in claim 4, wherein lithium oxide (Li₂O), lanthanum oxide (La₂O₃), calcium oxide (CaO), strontium oxide (SrO), titanium dioxide (TiO₂), arsenic oxide (Sb₂O₅), tantalum oxide (Ta₂O₅), chromium oxide (Cr₂O₃) or zinc oxide (ZnO) can be added to the oxides.

10. The processing method for ceramic as claimed in claim 4, wherein the sulphides can be iron sulphide (FeS) or manganese sulphide (MnS).

11. The processing method for ceramic as claimed in claim 4, wherein the chemical compound is ferric oxide (Fe₂O₃-MeO).

12. The processing method for ceramic as claimed in claim 4, wherein the chemical compound is ferric oxide (Fe₂O₃), and the ferric oxide (Fe₂O₃) can be compounded with nickel oxide (NiO), cobalt oxide (CoO), molybdenum oxide (MoO), magnesium oxide (MgO), zinc oxide (ZnO), cupric oxide (CuO), lithium oxide (Li₂O), calcium oxide (CaO), iron oxide (FeO), beryllium oxide (BeO), lead oxide (PbO), strontium oxide (SrO), lanthanum oxide (La₂O₃), chromium oxide (Cr₂O₃), tin oxide (SnO₂) or tungsten oxide (WO₃).

13. The processing method for ceramic as claimed in claim 12, wherein the nickel oxide (NiO), cobalt oxide (CoO), molybdenum oxide (MoO), magnesium oxide (MgO), zinc oxide (ZnO), cupric oxide (CuO), lithium oxide (Li₂O), calcium oxide (CaO), iron oxide (FeO), beryllium oxide (BeO), lead oxide (PbO), strontium oxide (SrO), lanthanum oxide (La₂O₃), chromium oxide (Cr₂O₃), tin oxide (SnO₂), tungsten oxide (WO₃) can be used alone or compounded.
